(19) United States
(12) Patent Application Publication
(10) Pub. No.: US 2024/0424971 A1
(43) Pub. Date: Dec. 26, 2024

(54) SOLAR TABLE MOBILE TRANSPORT WITH SIDESHIFT AND WINGS

(71) Applicant: Terabase Energy, Inc., Berkeley, CA (US)

(72) Inventors: Adam Hansel, Davis, CA (US); Tyler Grushkowitz, Corvallis, OR (US); Brian Coleman, Portland, OR (US); Soren Jensen, Corte Madera, CA (US)

(73) Assignee: Terabase Energy, Inc., Berkeley, CA (US)

(21) Appl. No.: 18/370,862

(22) Filed: Sep. 20, 2023

Related U.S. Application Data
(63) Continuation-in-part of application No. 18/214,245, filed on Jun. 26, 2023.

(51) Int. Cl. B60P 3/00; H02S 20/00

(52) U.S. Cl. CPC B60P 3/002; H02S 20/00

(57) ABSTRACT

A solar table mobile transport with sideshift capability is described that moves a solar table to a point of installation. The solar table mobile transport comprises multiple motors that allow movement within a three-dimensional coordinate system as well as provide angular controls of pitch, yaw, and roll. Extended horizontal movement of the solar table is provided by a sideshift element that extends the solar table beyond an edge of a transport component of the solar table mobile transport. The mobile transport may incorporate wings to prevent the solar table from rotating during transportation. The wings may be adjustable such that the solar table may be maneuvered in height and pitch/roll/yaw angle into an installation instance before unloading. Such a capability of sideshft in combination of instance adjustment facilitates an installation process of the solar table.

### CROSS-REFERENCE TO RELATED APPLICATIONS

This application is a continuation-in-part of U.S. patent application Ser. No. 18/214,245 (Docket No. 20179-2569US), filed on Jun. 26, 2023, entitled “SOLAR TABLE MOBILE TRANSPORT WITH SIDESHIFT”, and listing Adam Hansel, Tyler Grushkowitz, Brian Coleman, and Soren Jensen as inventors. The aforementioned patent document is incorporated by reference herein in its entirety.

### TECHNICAL FIELD

The present disclosure relates generally to a motorized solar table transport with horizontal sideshift capability that is used in the construction of large-scale solar systems. More particularly, the present disclosure relates to a motorized solar table transport with horizontal sideshift capability that moves a solar table from a solar table assembly factory to an installation point and provides extended horizontal, vertical and angular movement of a solar table for alignment to a specific installation site within the large-scale solar system.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is cost-effective management of the construction process and the ability to efficiently move components around the site during the construction process.

Large-scale solar panel systems typically include thousands of solar panels that are located across a multi-acre terrain and that are electrically coupled to provide a source of energy. These large-scale systems are oftentimes located in remote areas and require a significant investment in materials, resources and labor in their installation and design. The sourcing and delivery of materials and resources for these installations can be problematic and inconsistent. A further complication is the reliable and safe movement of these materials and resources across large areas of the construction site as well as maintaining consistent installation processes at each point of installation within the site. These issues further contribute to an increase in the cost and complexity of what is already a very cost-sensitive process.

FIG. 1 illustrates a typical prior-art installation process for solar systems. This prior-art installation process is implemented such that all mounting equipment for each solar panel is individually assembled and installed at its location within the larger system. The cost-effectiveness of this approach works fine within smaller solar deployments but struggles to cost-effectively scale to large solar systems as described below.

This traditional deployment 101 relies on materials being delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is then repeated for an adjacent location 103 where materials are subsequently delivered, assembled and installed for a neighboring solar table within the system. While this approach may be effectively deployed in the installation of smaller solar systems, it becomes cost-prohibitive as the size of the system increases.

What is needed are systems, devices and methods that reduce the complexity and cost of the installation of large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIGURE (“FIG.”) 1 shows a prior art assembly and installation process of large-scale solar panel systems.

FIG. 2 is a diagram showing a centralized assembly and installation of a solar system including mobile transport of solar tables in accordance with various embodiments of the invention.

FIG. 3 is an exemplary sequence of diagrams illustrating an installation of a solar table within a solar system using a mobile transport according to various embodiments of the invention.

FIG. 4 is a side view of a solar table mobile transport with sideshift capability according to various embodiments of the invention.

FIG. 5 is a front view of a first solar table mobile transport with sideshift capability in accordance with various embodiments of the present invention.

FIG. 6 is a front view of a second solar table mobile transport with sideshift capability in accordance with various embodiments of the present invention.

FIG. 7 is a front view of a solar table mobile transport with sideshift capability and at least one stabilizer according to various embodiments of the invention.

FIG. 8 is a front view of a solar table mobile transport with sideshift capability and at least one counterweight according to various embodiments of the invention.

FIG. 9 illustrates a front view of a mobile transport with anti-rotational wings in accordance with various embodiments of the invention.

FIG. 10 is a prospective view of a sideshift element with anti-rotational wings in a retracted position in accordance with various embodiments of the invention.

FIG. 11 is a front view of a sideshift element with anti-rotational wings in a retracted position in accordance with various embodiments of the invention.

FIG. 12 is a prospective view of a sideshift element with anti-rotational wings in a deployed position in accordance with various embodiments of the invention.

FIG. 13 is a front view of a sideshift element with anti-rotational wings in a deployed position in accordance with various embodiments of the invention.

FIG. 14 is a diagram illustrating a mobile transport rotating a solar table for installation according to various embodiments of the invention.

FIG. 15 is a diagram illustrating a mobile transport having a solar tabled aligned for installation according to various embodiments of the invention.

FIG. 16 is a process of a mobile transport moving a solar table for installation according to various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of the solar table mobile transport with sideshift capability.

Furthermore, connectivity between components or systems within the figures are not intended to be limited to direct connections. Also, components may be integrated together or be discrete prior to construction of a solar panel mobile transport with sideshift capability.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently across different solar table mobile transports; and (4) certain functions may be performed concurrently or in sequence.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and personnel are difficult to manage and accurately predict. Additionally, embodiments of a solar table mobile transport may be implemented in smaller construction sites.

In this document, “large-scale solar system” refers to a solar system having 1000 or more solar panels. The word “resources” refers to material, parts, components, equipment or any other items used to construct a solar table and/or solar system. The word “personnel” refers to any laborer, worker, designer or individual employed to construct or install a solar table or solar system. The term “solar table” refers to a structural assembly comprising a torque tube and/or purlins with module rails. Some types of solar tables may have supplemental structure that allows it to connect to foundations/piles while other types do not have this supplemental structure. A solar table may have (but is not required) solar panels and/or electrical harnesses. The term “solar table mobile transport” (hereinafter, “mobile transport”) describes a vehicle used to move a solar table to an installation site and facilitate an installation process of the solar table. A mobile transport may be driven by personnel, controlled by remote control or move autonomously within at least a portion of a solar system construction site. The term “transport component” refers to a lower portion of the mobile transport that provides movement and includes wheels (or similar features such as a tractor assembly or robotic system), steering mechanism (autonomous or personnel driven) and braking mechanism. The term “solar table alignment and support component” (hereinafter referred to as a “STAS component”) is a structure that couples to the transport component and secures a solar table above the transport component. The STAS component provides alignment capability such that a torque tube and/or solar table may be moved in vertical, horizontal and angular motions. In certain embodiments, the STAS component comprises a sideshift structure that provides horizontal movement of the solar table beyond a plane defined by an outer edge of the transport component. In certain embodiments, the sideshift structure may also comprise a motor that provides horizontal movement of the solar table. The sideshift structure may be located anywhere within the STAS component including near the top or near the bottom of the STAS component. The term “motor” is defined as a structural device that produces motion of a solar table, this motion may be unidirectional or multidirectional. Examples of some motors may include elements such as actuators, tracks, etc. that help in producing motion of structures within the mobile transport or the solar table.

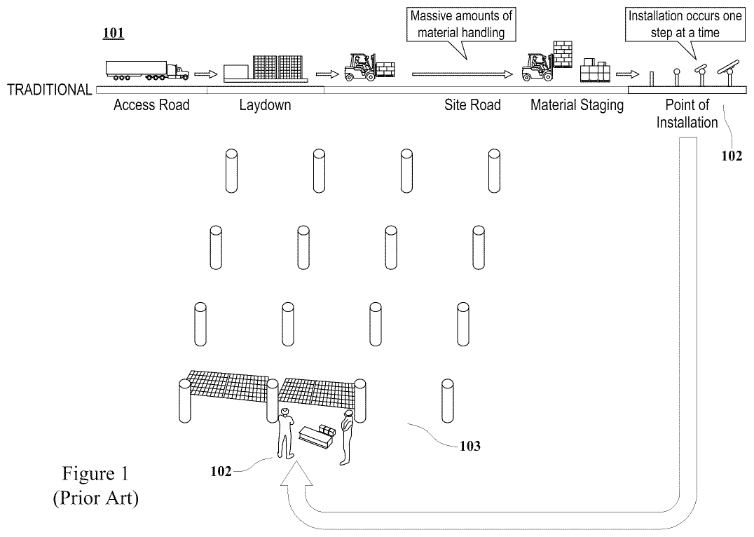

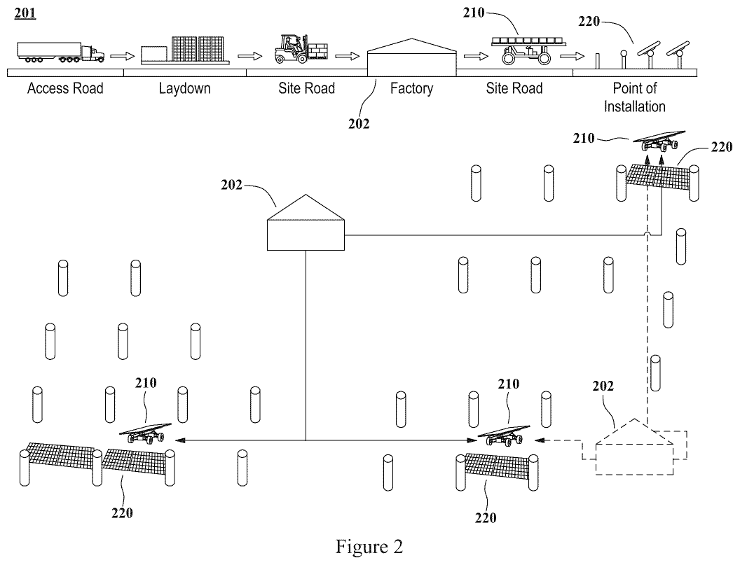

FIG. 2 provides an overview of a centralized solar table assembly and installation for large-scale solar systems according to various embodiments of the invention. Embodiments of the invention transition the prior art approach of assembly and installation at single location sites to a centralized and coordinated assembly factory that allows a more cost-effective and dynamic process of constructing large-scale solar systems. This centralized assembly of solar system components, such as solar tables, necessitates a more robust transport vehicle to move the pre-assembled components to the installation site. Additionally, the installation of these pre-assembled components may require functionality to support the alignment and integration of these components into the system. This alignment of a solar table secured on a mobile transport to a particular installation site is aided by horizontal motion facilitated by a sideshift structure and vertical motion via a STAS component.

Resources are brought to construction site 201 for a large-scale solar systems and initially processed. These resources are delivered to one or more assembly factories 202 where a coordinated and centralized solar table assembly process is performed. In certain embodiments, a construction site may have multiple centralized factories 202. As shown in FIG. 2, there are two centralized factories 202 strategically located at the site. The location and number of centralized factories 202 may depend on several parameters including the size of the site, the terrain of the site, the design of the site and other variables that relate to the construction of the large-scale solar system.

Assembled solar tables and equipment are moved from factory 202 to a point of installation 220 via motorized vehicles 210 such as mobile transports with sideshift capability. In certain embodiments, the mobile transports are specifically designed to transport solar tables along a site road to the point of installation 220. As previously mentioned, the mobile transports 210 may be driven by personnel, may be controlled by remote control or autonomously driven by a computer system. The time and/or sequence in which solar tables are delivered to points of installation 220 may depend on a variety of factors that may be analyzed to configure a preferred schedule.

Delivery of an assembled solar table to an installation site requires an alignment process to securing points at the installation site. Because an assembled solar table is oftentimes large and heavy, this alignment process may be difficult and require significant effort by personnel to properly align both ends of a solar table to receptors, piles or other coupling elements at the installation site. Embodiments of the solar table mobile transport with sideshift capability allows motorized alignment of the solar table while it is still secured to the mobile transport. The sideshift capability also allows a less precise positioning of the mobile transport at the installation site due to the sideshift capability to provide extended horizontal movement of the solar table. As a result, the mobile transport is parked proximate to the installation site but does not require precise parking to initiate an alignment and installation process.

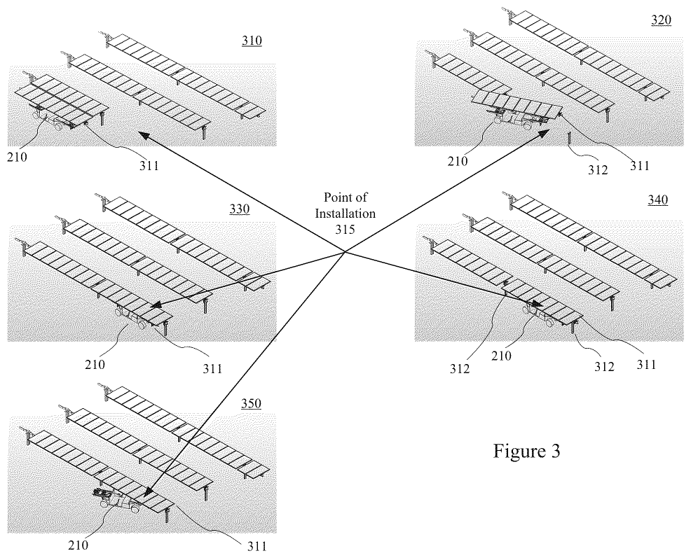

FIG. 3 illustrates a sequence of installation steps of a solar table at an installation site using a solar panel mobile transport with sideshift capability according to various embodiments of the invention. As shown in 310, a mobile transport 210 supporting a solar table 311 approaches a point of installation 315. The solar table 311 is secured to the mobile transport 210 by a solar table attachment component that securely holds the solar table above the mobile transport 210. In certain embodiments, the solar table 311 is assembled and secured to the attachment component at a centralized assembly factory and subsequently driven to the point of installation 315.

As shown in 320, the mobile transport 210 approaches the point of installation 315 in preparation for installation within the solar system. The point of installation 315 comprises structures used to secure the solar table 311 within the system. For example, a solar table 311 may be secured to a previously installed table whereby a torque tube in the solar table 311 is inserted into a previously installed table. The previously installed table may be secured to a pile 312 where threaded fasteners/rivets connect its bearing housing assembly/brackets to the pile 312. As shown in 330, the mobile transport 210 aligns the solar table 311 at the point of installation 315 for subsequent integration into solar system. This alignment process will be discussed in more detail below and includes alignment along a three-dimensional coordinate system as well as angular control of yaw, pitch and roll. As previously stated, sideshift capability on the mobile transport 210 allows for this alignment when the mobile transport 210 is located proximate to the installation site and does not require precise parking of the mobile transport relative to the location site.

As shown in 340, the solar table is secured within the solar system after alignment is completed. This securitization process includes attached the solar table 311 to piles 312 that lock the solar table in line with adjacent solar tables. One skilled in the art will recognize that other processes may be employed to securely lock a solar table 311 within the system and may use other components that replace or supplement the piles 312.

As shown in 350, mobile transport 210 detaches from the solar table 311 after an alignment process has occurred using horizontal, vertical and angular control as needed. The STAS component lowers after the solar table 311 is secured within the system so that the mobile transport 210 may leave the point of installation 315.

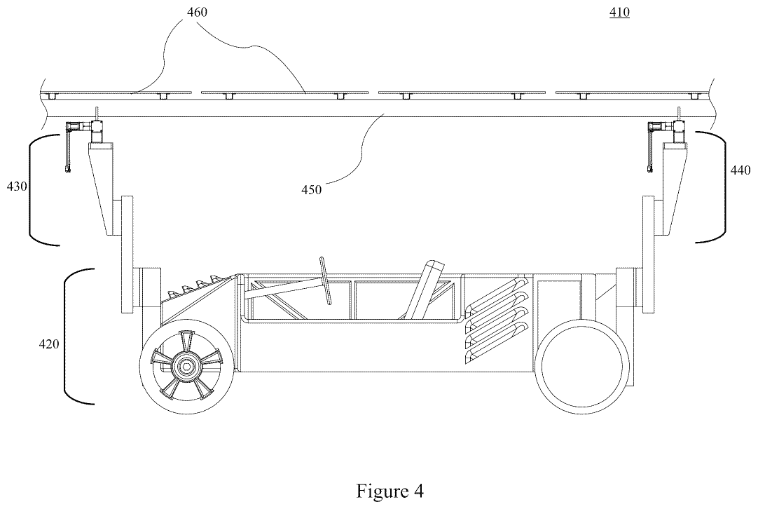

FIG. 4 illustrates a side view of a mobile transport with sideshift capability in accordance with various embodiments of the invention. This mobile transport 410 comprises a first STAS component 430, a second STAS component 440 and a transport component 420 that support a robust vehicle that can securely move solar tables to an installation point and perform alignment and integration of the solar table into the solar system. In this example, the first STAS component 430 and the second STAS component 440 are coupled to a torque tube 450 and provide both vertical and horizontal movement of the solar table having multiple solar panels 460. In certain embodiments, the first and second STAS components 430, 440 comprise multiple motors that cause horizontal and vertical movement of the solar table. The horizontal and vertical movement caused by the first STAS component 430 and the horizontal and vertical movement caused by the second STAS component 440 operate at least partially independent of each other to enable angular control of the torque tube and/or solar table. This angular control (as well as the horizontal and vertical movements) allows a dynamic alignment process of the torque tube 450 within the installation site. According to various embodiments, the horizontal, vertical and angular motion of the torque tube 450 may be motorized or controlled by personnel by applying force to the torque tube 450 or other component(s) on the solar table.

The transport component 420 comprises a vehicular segment that can move throughout a solar system construction site under the control of a driving system. Examples of the vehicular segment include a wheel system, tractor system and/or robotic movement system that moves a solar table from a factory to an installation point. The transport component 420 comprises a driving system that effectively controls the movement of the mobile transport as it carries a solar table from a centralized, factory to an installation site. Examples of a driving system include systems that are controlled by an in-vehicle driver, a remote control being used by personnel or an autonomous driving system. If an autonomous driving system is employed, the transport component 420 comprises autonomous driving capabilities which include both a vehicle location element (such as a GPS location, autonomous sensor and image processing, and/or virtual construction site map including roads between factories and installation sites). One skilled in the art will recognize that the transport component 420 may be modified and/or supplemented with a variety of structural and functional elements to further assist in the transportation of solar tables within a solar system construction site.

The STAS components 430, 440 may be located above and coupled to the transport component 420. The STAS components 430, 440 may also be an extension to transport component 420 at a variety of angles and across one or more portions of the STAS components 430, 440. The STAS components 430, 440 comprise a plurality of attaching elements that securely attach to a solar table. In one example, the attaching elements are end effectors that securely hold a torque tube 450 to allow movement and alignment processes. As previously described, the STAS components 430, 440 also includes independent motors that position and align a solar table within a three-dimensional space as well as control angular movement to facilitate proper integration into a system. As will be described in more detail below, these motors can provide alignment of heavy structures, such as solar tables, with personnel controlling the motors or autonomous control where alignment movement is driven by sensors.

Solar table securing clamps, such as end effectors, may be positioned anywhere on the STAS components 430, 440 to securely hold a variety of different shapes and types of solar tables. In one embodiment, the solar table securing clamps are positioned along an axis to allow secure attachment to a torque tube 450 of a solar table. This torque tube 450 may have other components, such as solar panels 460, attached to it.

One skilled in the art will recognize that the attachment component may be modified and/or supplemented with a variety of structural and function elements to further assist in the attachment process to a solar table or the alignment/installation process of the solar table within the solar system. These attachment components may couple to any structural part of the solar table in accordance with different embodiments of the invention.

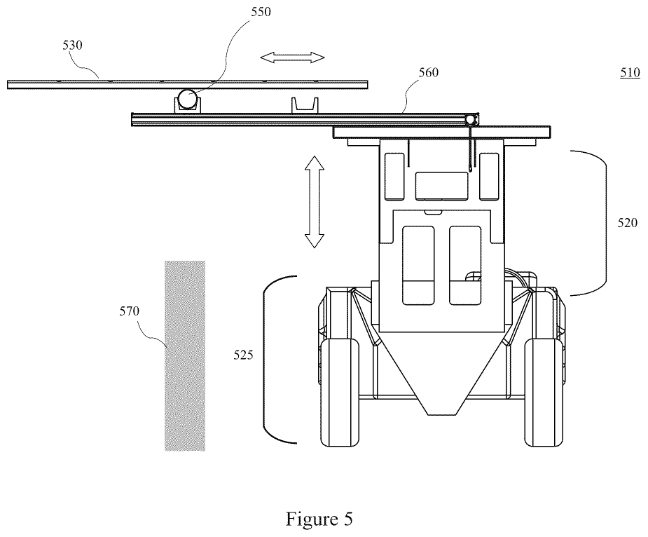

FIG. 5 illustrates a front view of a mobile transport with sideshift capability in accordance with various embodiments of the invention. The mobile transport 510 comprises a transport component 525 that provides movement to the mobile transport. The mobile transport 510 also comprises a first STAS component 520 and a second STAS component that is not shown and positioned behind the first STAS component 520. The first STAS component 520 comprises a sideshift element 560 that provides horizontal motion of a solar table 530. The sideshift element 560 is coupled to the solar table at the torque tube 550. In this particular example, the sideshift element 560 is shown as a rail having a motorized track that moves the solar table 530 along a horizontal plane. One skilled in the art will recognize that the sideshift element may be realized in a variety of different structures and may be motorized or manually controlled by personnel.

In this example, mobile transport 510 is parked proximate to a pile 570 to which the solar table 530/torque tube 550 is to be aligned and secured. In many instances, the torque tube 550 is secured at two or more securing elements (e.g., between two adjacent solar tables, between two piles, a combination thereof, or other types of securing elements). The sideshift capability of the mobile transport 510 allows it to be parked proximate to these piles 570 instead of between the piles. In particular, the sideshift element 560 provides extended horizontal movement of the solar table 530 to facilitate alignment without the mobile transport 510 being positioned in between the securing elements.

As previously described, the STAS component 520 (along with the second STAS component) facilitates horizontal, vertical and angular control such that the heavy solar table 530 is properly positioned relative to the securing elements to allow appropriate installation at the site.

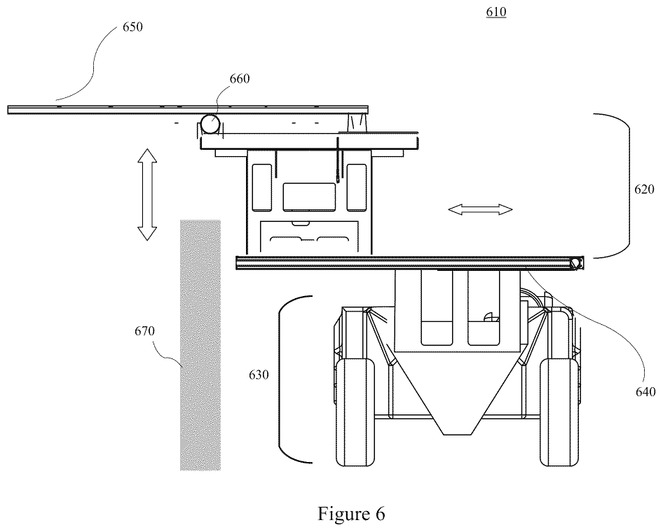

FIG. 6 is a front view of another example of a mobile transport with sideshift capability in accordance with various embodiments of the invention. In this particular example, the sideshift element is positioned near the bottom of the STAS components.

Referring to this figure, the mobile transport 610 comprises a transport component 630 and a first STAS component 620 (the second STAS component is not shown but positioned behind the first STAS component). The sideshift element 640 is positioned near the bottom of the first STAS component 620. A torque tube 660 on a solar table 650 is coupled to the first STAS component 620 so that horizontal, vertical and angular motion may be performed during an alignment process. In this embodiment, the sideshift element 640 provides extended horizontal movement of the torque tube 660/solar table 650. As was the case in the first example, the extended horizontal movement provided by the sideshift element 640 allows for less precise positioning of the mobile transport 610 relative to the installation site. Accordingly, the mobile transport 610 should be parked sufficiently close to the pile 670 so that the extended horizontal movement allows horizontal alignment between the torque tube 660 and the pile 670.

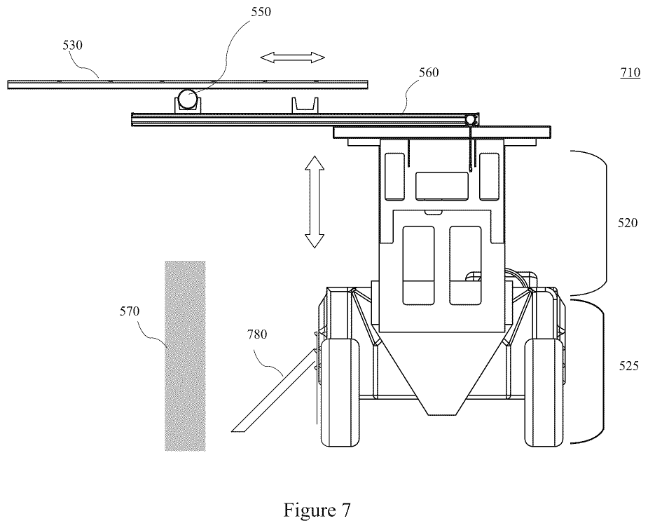

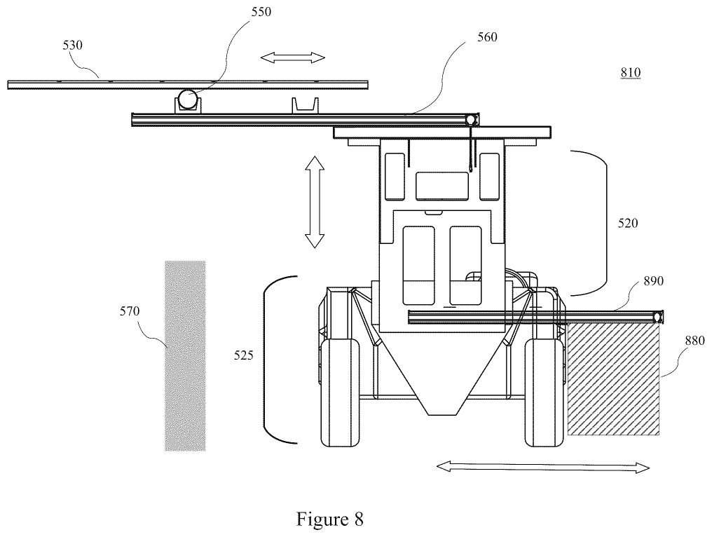

In certain instances, as a solar table mounted on a sideshift element is extended horizontally beyond the edge of the transport component, the mobile transport may become unstable due to the downward force applied at the end of the sideshift element. In order to correct this instability, certain embodiments of the mobile transport may have compensation elements that counter this destabilizing force. Two examples of compensation elements are illustrated in FIGS. 7 and 8.

FIG. 7 illustrates a mobile transport 710 that comprises at least one stabilizer that prevents tipping or unwanted movement of the mobile transport when a solar table is extended horizontally according to various embodiments of the invention. In this example, a stabilizer leg 780 extends horizontally and downward from the same side of the mobile transport relative to the horizontally extended solar table such that one side of the leg is positioned on the ground and the other side of the leg is positioned on the mobile transport 710. This stabilizer leg 780 reduces tipping on the mobile transport 710 as the solar table 530 is extended.

One skilled in the art will recognize that the shape and size of the stabilizer leg 780 may vary based on a variety of factors including the weight, size and shape of the mobile transport 710, the weight, size and shape of the solar table 530, the terrain in which the mobile transport is operating, and the distance of which the solar table 530 is extended. Other factors may also relate to the shape and size of the stabilizer leg 780. Additionally, multiple stabilizer legs may be employed on the mobile transport 710.

FIG. 8 illustrates a mobile transport with sideshift capability that includes a counterweight in accordance with various embodiments of the invention. In this example, a moveable counterweight 880 is provided that moves along a rail 890 so that the mobile transport 810 may be stable during horizontal extension of the solar table 530. As shown, the counterweight 880 is positioned on the opposite side of the extended solar table 530 to reduce tipping or movement of the mobile transport 810.

One skilled in the art will recognize that the size, weight and shape of the counterweight 880 may vary depending on a variety of parameters previously discussed. Furthermore, the manner in which the counterweight 880 moves may vary across different embodiments of the invention.

One skilled in the art will recognize that a solar table may have a variety of different support structures such as beams, purlins, etc., that either supplement or replace a torque tube. All of these different solar type examples are intended to fall within the scope of certain embodiments of the invention and the different ways in which the solar table is coupled to the mobile transport is intended to fall within the scope of certain embodiments of the invention.

One skilled in the art will recognize that the different movements supported by the mobile transport support robust alignment processes that allow for a more efficient and accurate alignment of a solar table to a corresponding mounting structure. In some embodiments, the alignment process(es) may be performed manually by personnel at the installation site that control each of the motors during alignment. In other embodiments, the alignment process(es) may be automatically performed by sensors and motor controls such that motor movement is controlled by computerized analysis of sensor data and/or image data. A variety of sensor technologies may be employed by a mobile transport such as LiDAR, camera sensors, radar sensors and other sensor technologies known to one of skill in the art. Furthermore, active and passive sensor systems may also be deployed.

In certain examples, detachable sensor systems may be positioned on a solar table (such as on a torque tube) prior to or during installation of the solar table. The detachable sensor device/system may be removed from the solar table once installation is complete and positioned on another table that needs to be installed within the system.

In other examples, the alignment process may comprise both manual and automated processes that result in the installation of a solar panel within the system.

The mobile transport may also include verification devices that confirm a solar table has been properly installed. These verification devices may include sensors that measure movement under a test force of the solar table to determine whether a swaged end is tightly inserted within a corresponding mounting structure.

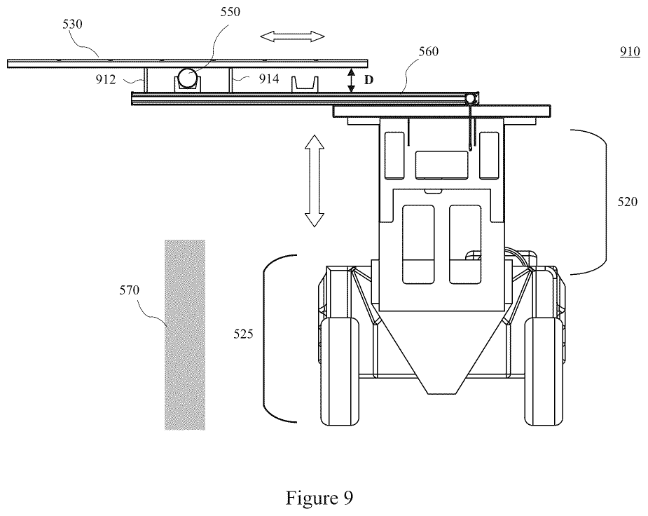

Given that the solar table is supported at the torque tube on a mobile transport, the solar table may be prone to rotation around the torque tube during transportation. Such a rotation could cause undesired damage to the solar table. FIG. 9 illustrates a front view of a mobile transport with anti-rotational wings in accordance with various embodiments of the invention. The mobile transport 910 is similar in structure as the mobile transport 510, with further incorporation of anti-rotational wings. The mobile transport 910 comprises a transport component 525 that provides movement to the mobile transport, a first STAS component 520, and a second STAS component that is not shown and positioned behind the first STAS component 520. The first STAS component 520 comprises a sideshift element 560 that provides horizontal motion of a solar table 530. The sideshift element 560 is coupled to the solar table at the torque tube 550. In this particular example, the sideshift element 560 is shown as a rail having a motorized track that moves the solar table 530 along a horizontal plane.

The sideshift element 560 has a first wing 912 and a second wing 914 positioned on both sides of the torque tube 550 when the sideshift element 560 is coupled to the solar table at the torque tube 550. The first wing 912 and the second wing 914 support module frames or module rails of the solar table and thus keep the table from rotating during transport. The wings may be manually operated or actuated with a pneumatic/hydraulic/linear actuator. For example, the wings may be in a retracted position during a loading process of the solar table on the sideshift element 560. Once the solar table is loaded, the wings may be operated, manually, pneumatically, or hydraulically, to a deployed position to prevent the solar table from rotating, and thus securely supporting the solar table.

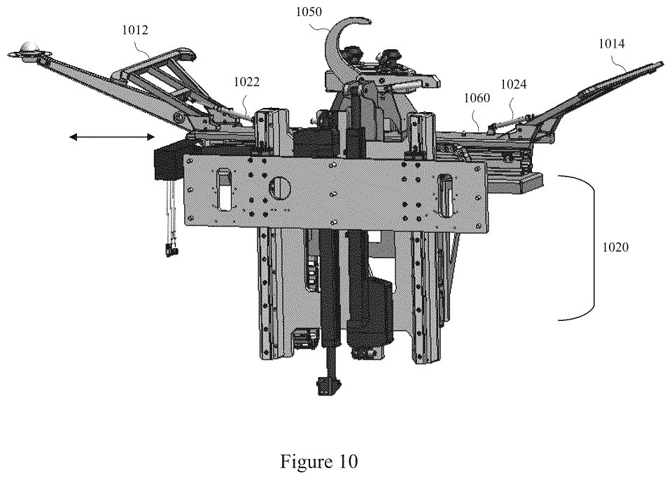

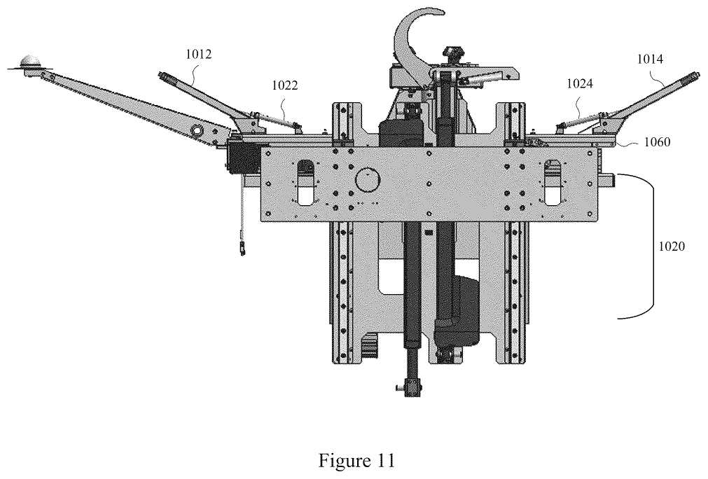

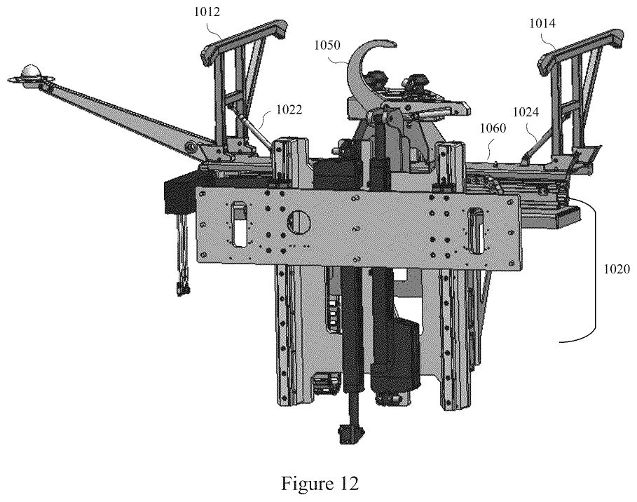

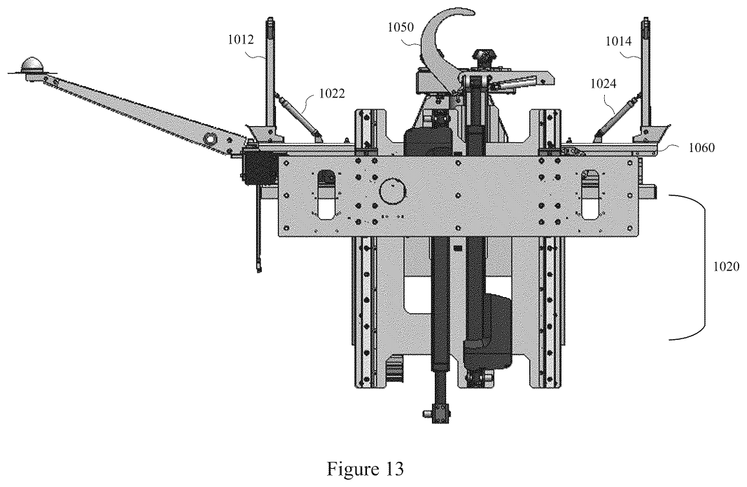

FIG. 10 and FIG. 11 respectively depict a prospective view and a front view of a sideshift element with anti-rotational wings in a retracted position in accordance with various embodiments of the invention. FIG. 12 and FIG. 13 respectively depict a prospective view and a front view of a sideshift element with anti-rotational wings in a deployed position in accordance with various embodiments of the invention. A STAS component 1020 supports a sideshift element 1060 that provides horizontal motion of a solar table (not shown in FIGS. 10-11). A first anti-rotational wing 1012 and a second anti-rotational wing 1014 are displaced on the sideshift element 1060 such that both winds may have horizontal movement along with the sideshift element 1060. Also displaced on the sideshift element 1060 is a tube hook 1050, which may be rotatable to engage a torque tube of a solar table and function in collaboration with the anti-rotational wings 1012/1014 to provide a stable and secure support for the solar table. The STAS component 1020 may be placed on a front end, a back end, or both ends of a mobile transport.

The first anti-rotational wing 1012 and the second anti-rotational wing 1014 may be operable to be in a detracted position as shown in FIGS. 10-11, or in a deployed position as shown in FIGS. 12-13. As shown in the FIGS. 11-13, the first anti-rotational wing 1012 and the second anti-rotational wing 1014 may be controlled by a first piston 1022 and a second piston 1024, respectively, for retracting or deploying. The pistons may be pneumatic/hydraulic pistons or linear actuators operable manually or automatically. The first piston 1022 and the second piston 1024 may be operated synchronically or independently.

In one or more embodiments, a deployment height of the first anti-rotational wing 1012 and the second anti-rotational wing 1014 may be controllable by setting a desired travelling distance of the first piston 1022 and the second piston 1024, such that the first anti-rotational wing 1012 and the second anti-rotational wing 1014 may be used to support various solar tables with different specifications, e.g, different distance D between the solar table and the sideshift element 560, as shown in FIG. 9.

Although pistons are used in the embodiments shown in FIGS. 10-13 to control the anti-rotational wing, one skilled in the art shall understand that the anti-rotational wings may be operated using various mechanisms, such as spring loading or gear loading, etc. Those variations shall also be within the scope of the invention.

The combination of vertical motion of the STAS component and horizontal motion of the sideshift element provides enhanced maneuverability for the mobile transport. A precise parking of the mobile transport relative to the location site is not required. The mobile transport can park in proximity (instead of in precision) and cantilever the solar table across pile line for on-site installation. Therefore, the efficiency of solar table unloading from the mobile transport may be increased significantly. The anti-rotational wings can provide stable support not only for transporting the solar table transportation but also for maneuvering the solar table after the mobile transport is parked. Additionally, given that the parking spot relative to a solar table installation location may not be even, the mobile transport can adjust accordingly such that the solar table may be still leveled during unloading. Such an adaptive capability further facilitates on-site solar-table installation.

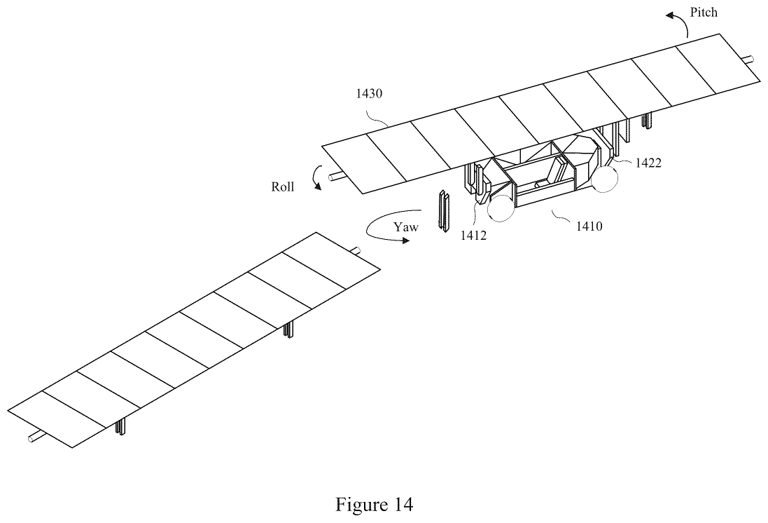

FIG. 14 is a diagram illustrating a mobile transport rotating a solar table for installation according to various embodiments of the invention. As shown in the Figure, a mobile transport 1410 supporting a solar table 1430 approaches a point of installation. The solar table 1430 is secured to the mobile transport 1410 by multiple supporting components, e.g., the tube hook 1050 and the anti-rotational wings 1012/1014 as described in FIGS. 11-13. The mobile transport 1410 comprises a first STAS component 1412 and a second STAS component 1422, each of which may comprise a sideshift element coupled to the solar table at the torque tube. The sideshift elements of both STAS components may operate, collaboratively or independently, to provide a horizontal motion and/or a yaw rotation of the solar table 1430.

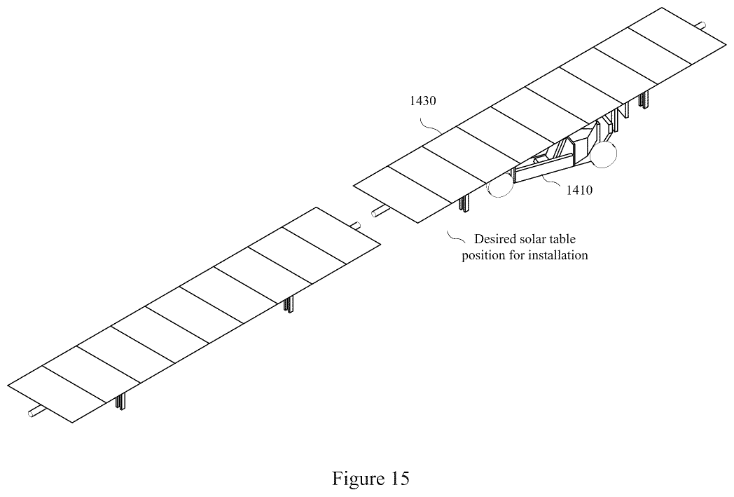

The first STAS component 1412 and the second STAS component 1422 may be height-adjustable. Both STAS components may operate independently or collaboratively such that the solar table 1230 may be raised, lowered, and/or adjusted in pitch angle. In one or more embodiments, the solar table 1230 may even be adjusted in roll angle by adjusting height of one or more anti-rotational wings. Such a combination of maneuver capability delivers superior flexibility for the mobile transport 1210. Precise parking of the mobile transport relative to installation piles is no longer required. The mobile transport just needs to be parked in proximity to an installation spot. Additionally, the mobile transport may be able to overcome various environmental obstacles, e.g., uneven ground, limited parking space at an installation spot, etc. With one or more movements, e.g., sideshift, height adjustment, height/pitch/roll adjustment, etc., the solar table may be aligned to a desired position ready for installation, as shown in FIG. 15.

In one or more embodiments, the anti-rotational wings may be incorporated on one STAS component, while the other STAS component may incorporate no anti-rotational wings at all. Such a simplified support may still be enough to provide a secure anti-rotational support for the solar table with a lower cost.

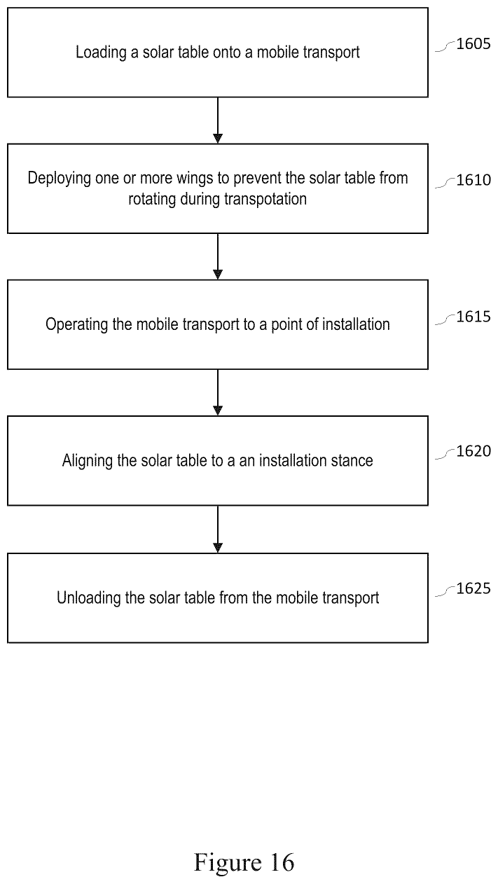

FIG. 16 depicts a process of a mobile transport moving a solar table for installation according to various embodiments of the invention. In step 1605, a solar table is loaded onto a mobile transport, which comprises STAS components, sideshift elements to provide horizontal motion, and anti-rotational wings. In step 1610, the anti-rotational wings are deployed to support the solar table and thus preventing the solar table from rotating during transportation. In one or more embodiments, one or more of the anti-rotational wings may be operated to deploy at a desired height to support the solar table in a leveled (horizontal) position before transportation starts. In step 1615, the mobile transport is operated, by a driver, a remote operator, or autonomously, to a point of installation.

In step 1620, the mobile transport aligns the solar table to a pre-determined stance or an installation stance with one or more movements, e.g., raising or lowering a height, adjusting a pitch angle, and/or adjusting a roll angle, etc. The alignment of the solar table may be implemented based on one or more parameters, such as an installation height for the solar table, a designed X-Y orientation of the solar table, ambient environment information of the point of installation, etc. The ambient environment information, such as a ground slope or a ground tilt at the point of installation may be obtained via on-board sensors (e.g., level sensors) in the mobile transport. The ground slope and/or the ground tilt are compensated when the mobile transport aligns the solar table to the installation stance. In one or more embodiments, the mobile transport may use various coordinate systems, such as Cartesian coordinates, polar coordinates, delta coordinates, robot arm coordinate, etc., for solar table alignment. In step 1625, once the solar table is aligned to the installation stance, the solar table is unloaded, e.g., retracting the anti-rotational wings and disengaging the tube hook from the torque tube, from the mobile transport for installation.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A mobile transport for moving a solar table, the mobile transport comprising:
a transport component operable to move the solar table from a first location to a point of installation; and
a first wing and a second wing that are deployable to support the solar table to prevent the solar table from rotating during transportation.

2. The mobile transport of claim 1 further comprising:
a first solar table alignment and support (STAS) component coupled to the transport component on a first end, the first STAS component comprises a first sideshift element that enables horizontal motion of the solar table; and
wherein the first wing and the second wing are placed on the first sideshift element.

3. The mobile transport of claim 2 further comprising:
a second STAS component coupled to the transport components on a second end, the second STAS component comprising:
a second sideshift element that enables horizontal motion of the solar table; and
a third wing and a fourth wing placed on the second sideshift element, the third wing and the fourth wing are deployable to support the solar table to prevent the solar table from rotating during transportation.

4. The mobile transport of claim 3 wherein the first and second sideshift elements are operated collaboratively or independently.

5. The mobile transport of claim 3 wherein the first wing and the second wing are positioned on both sides of a torque tube of the solar table when the first sideshift element is coupled to the solar table at the torque tube, the third wing and the fourth wing are positioned on both sides of the torque tube when the second sideshift element is coupled to the solar table at the torque tube.

6. The mobile transport of claim 3 wherein the first wing, the second wing, the third wing, and the fourth wing are operated independently or collaboratively.

7. The mobile transport of claim 3 wherein the first wing, the second wing, the third wing, and the fourth wing are manually, hydraulically, or pneumatically operated to support the solar table.

8. The mobile transport of claim 3 wherein each of the first wing, the second wing, the third wing, and the fourth wing is controlled by a piston for a deployment height that is controllable by a setting desired travelling distance of the piston.

9. The mobile transport of claim 3 wherein at least one of the first STAS component and the second STAS component is operated to align the solar table in an installation instance once the mobile transport arrives at the point of installation.

10. The mobile transport of claim 9 wherein aligning the solar table comprises one or more of:
raising or lowering a height of the solar table;
sideshifting the solar table;
adjusting a pitching angle of the solar table;
adjusting a yaw angle of the solar table; and
adjusting a roll angle of the solar table.

11. A method for moving a solar table for installation, the method comprising:
loading the solar table on to a mobile transport at a first location, the mobile transport comprises at least one pair of anti-rotational wings that are deployable;
deploying the at least one pair of anti-rotational wings to support the solar table to prevent the solar table from rotating during transportation;
operating the mobile transport to move the solar table from the first location to a point of installation; and
aligning the solar table to an installation stance.

12. The method of claim 11 wherein the at least one pair of anti-rotational wings comprise a first pair of anti-rotational wings and a second pairs of anti-rotational wings;
wherein the first pair of anti-rotational wings is placed on a first sideshift element on a first solar table alignment and support (STAS) component located on a first end of the mobile transport, the second pair of anti-rotational wings is placed on a second sideshift element on a second STAS component located on a second end of the mobile transport, the first and second sideshift elements enable horizontal motion of the solar table.

13. The method of claim 12 wherein loading the solar table on to the mobile transport comprises:
vertically moving at least one of the first STAS component and the second STAS component to support the solar table in a leveled position for transportation.

14. The method of claim 11 wherein each anti-rotational wing of the at least one pair of anti-rotational wings is operated independently or collaboratively.

15. The method of claim 11 wherein the at least one pair of anti-rotational wings are manually, hydraulically, or pneumatically operated to support the solar table.

16. The method of claim 11 wherein each anti-rotational wing of the at least one pair of anti-rotational wings is controlled by a piston for a deployment height that is controllable by setting a desired travelling distance of the piston.

17. The method of claim 12 wherein aligning the solar table to the installation stance comprises one or more of:
raising or lowering a height of the solar table;
sideshifting the solar table to an extended position;
adjusting a pitch angle of the solar table; and
adjusting a yaw angle of the solar table.

18. The method of claim 11 wherein the installation stance is determined based on one or more of:
an installation height for the solar table; and
a designed X-Y orientation of the solar table.

19. The method of claim 18 wherein aligning the solar table to the installation stance is implemented based on ambient environment information at the point of installation, the ambient environment information comprises at least one of a ground slope and a ground tilt at the point of installation.

20. The method of claim 19 wherein the ground slope and/or the ground tilt are compensated when the mobile transport aligns the solar table to the installation stance.
